(19) United States
(12) Patent Application Publication
(10) Pub. No.: US 2017/0007954 A1
(43) Pub. Date: Jan. 12, 2017

(54) Air Purifier System

(71) Applicant: Sassan Ehdaie, Houston, TX (US)

(72) Inventor: Sassan Ehdaie, Houston, TX (US)

(21) Appl. No.: 15/205,227

(22) Filed: Jul. 8, 2016

Related U.S. Application Data
(60) Provisional application No. 62/189,902, filed on Jul. 8, 2015.

(51) Int. Cl. B01D 47/02; F24F 3/16; C25B 1/10

(52) U.S. Cl. CPC B01D 47/02; C25B 1/10; F24F 3/1603; F24F 2003/1617; F24F 2003/1682; F24F 2003/1692

(57) ABSTRACT

An air purifier system for removing particulate matter and gaseous particles from polluted indoor air is provided. The air purifier system comprises a filtration chamber having an amount of water. The filtration chamber receives the polluted indoor air with the polluted indoor air traveling through the water leaving behind particulate matter and gaseous particles in the water and cleaned air exiting the filtration chamber. An electrolyzer continuously electrolyzes distilled water to generate hydrogen molecules and oxygen molecules in an electrolysis process with the oxygen gases added to the cleaned air exiting the filtration chamber. A fuel cell receives the hydrogen gases from the electrolyzer for generating electricity with the fuel cell electrically connected to at least the electrolyzer for at least partially powering the electrolyzer. The cleaned air exits the filtration chamber is free from particulate matter and gaseous particles.

### CLAIM OF PRIORITY

This patent application claims priority under 35 USC 119 (e) (1) from U.S. Provisional Patent Application Ser. No. 62/189,902 filed Jul. 8, 2015, of common inventorship herewith entitled, “Alpine Breeze Air Purifier,” which is incorporated herein by reference as though the same were set forth in its entirety.

### FIELD OF THE INVENTION

The present invention pertains to the field of healthy living, and more specifically to the field of air purifiers.

### BACKGROUND OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention.

Most inventions fill a relatively small need or perform a specialized limited function. If that need is shared by a sufficient number of consumers, an invention has a great potential for success. Breathing air purified of airborne contaminants is a common challenge and desired outcome shared by owners of residential structures and commercial buildings.

The prior art has put forth several designs for air purifiers. Among these are:

US Patent 2014/101262 to Zhiqiang Zhou describes an air purification device, wherein a main body comprises air inlets at two sides. An air extractor at an air outlet draws in air. When entering, the air passes through a negative high voltage wire to carry on a negative charge and be sterilized. The air mixes with a nanoscale water mist sprayed out from a spray pipe and enters a dust collection board. The water mist is electrolyzed from water in a water supply tank by an electrolyzer to generate alkaline water which is supplied to a water storage tank and atomized by an ultrasonic atomizer prior to being ionized into a nanoscale water mist by nano electrodes so as to be sprayed out. When air flows through a water mist stream, charged contaminative gases mix with the water mist, separate from the air stream under the action of inertia and an attractive force from the electric field of the dust collection board, and collide with droplets to be captured, intercepted and collected. When PM 2.5 and other dusts in the air are wetted by the droplets to condense into larger particles, gravity settling is realized and particles with a certain weight fall into a waste water tank to be discharged out. The separated clean air is released out into the environment.

U.S. Pat. No. 6,955,715 to Nicholas D. Tittle describes a water based air filter system for recycling and cleaning the air found in industrial plants, in particular. The water based air filter system includes a support base. The system also includes a tank being disposed in the support base and being at least partially filled with water and having an inlet hole being disposed through a wall thereof, and having an outlet hole being disposed through the wall thereof. The tank further includes an air inlet spout being extended through the inlet hole and into the water in the tank and also includes an air outlet spout being extended through the outlet hole and being extended from the tank. An outside air suction assembly is mounted upon the support base and connected to the air inlet spout for drawing polluted air into the water in the tank.

U.S. Pat. No. 5,277,877 to Robert E. Jeffrey, R. Malone Hodges, William F. Dempster and Robert G. Hahn describes an indoor air purifier that has a base and a container on the base with a layer of soil supported above a lower water bath occupying the bottom of the container. The container is fitted on top of the base such that the container can freely rotate upon the base. Room air is drawn into the base and is passed from the base into the bottom of the container through a duct connected between the two. Air passing from the base is directed downwardly into the water bath before passing upwardly into the soil layer. The air passes through the soil layer and is discharged from the soil's surface back into the room. Contaminant gases and particulates are removed from the air through contact with the soil layer and are metabolized by microorganisms contained within the soil, producing carbon dioxide and water. The water bath humidifies the air being passed through it and maintains a stable degree of moisture in the lower portion of the soil layer. Water lost through evaporation is replenished through a sleeve passing downward from the soil's surface to the water bath. A water bottle inverted within the sleeve maintains a substantially constant water level. Plants may be grown in the soil layer to aid in purification and to provide an attractive room decor.

None of these prior art references describe the present invention.

### SUMMARY OF THE INVENTION

It is an object of the present invention to provide a water based air purifier that removes particulate matter and gaseous particles from indoor air and simultaneously increases the oxygen level in the same indoor air.

The present invention is an air purifier system for removing particulate matter and gaseous particles from polluted indoor air. The air purifier system comprises a filtration chamber having an amount of water. The filtration chamber receives the polluted indoor air with the polluted indoor air traveling through the water leaving behind particulate matter and gaseous particles in the water and cleaned air exiting the filtration chamber. An electrolyzer continuously electrolyzes distilled water to generate hydrogen molecules and oxygen molecules in an electrolysis process with the oxygen gases added to the cleaned air exiting the filtration chamber. A fuel cell receives the hydrogen gases from the electrolyzer for generating electricity with the fuel cell electrically connected to at least the electrolyzer for at least partially powering the electrolyzer. The cleaned air exits the filtration chamber is free from particulate matter and gaseous particles.

In addition, the present invention includes a method for removing particulate matter and gaseous particles from polluted indoor air. The method comprises providing a filtration chamber having an amount of water, introducing polluted indoor air into the filtration chamber, contacting the polluted indoor air with the water in the filtration chamber, removing particulate matter and gaseous particles in the water, and expelling cleaned air from the filtration chamber. Further providing an electrolyzer, continuously electrolyzing distilled water in the electrolyzer, generating hydrogen molecules and oxygen molecules in an electrolysis process, adding the oxygen molecules to the cleaned air exiting the filtration chamber, providing a fuel cell, introducing the hydrogen molecules from the electrolyzer into the fuel cell, generating electricity from the hydrogen molecules, electrically connecting the fuel cell to at least the electrolyzer, and at least partially powering the electrolyzer.

### BRIEF DESCRIPTION OF THE DRAWINGS

FIG. 1 is a functional, top down, diagrammed view of how the present invention works with components required for optimal functionality including a filtration chamber, a fuel cell, and an electrolyzer.

### DETAILED DESCRIPTION OF THE INVENTION

The present invention, hereinafter referred to as the Air Purifier System, indicated generally at 10, is a water based air purifier which removes particulate matter and gaseous particles from indoor air while simultaneously releasing oxygen molecules to increase oxygen levels in the air and releasing hydrogen molecules to generate electrical energy. The Air Purifier System 10 is specifically constructed so the contact between air and water is maximized to the extent that the air leaving the purifier is completely free of even minute amounts of pollutants. The Air Purifier System 10 uses the most advanced technology to add freshly generated oxygen that is added to the purified air and to generate electricity and water that are recycled into functional operations within the components. Freshly generated oxygen produced by the present invention, is more effective than oxygen from a cylinder.

The Air Purifier System 10 of the present invention is comprised of three main components including a filtration chamber 12, a fuel cell 14, and an electrolyzer 16. The fuel cell 14 and electrolyzer 16 are located outside the building or preferably in the attic while the filtration chamber 12 is located in the room. Polluted air 18 enters the filtration chamber 12 and travels through a bulk of water leaving behind particulate matter and gaseous particles in the water. In leaving the filtration chamber 12, the air goes through a waterproof air permeable membrane 20 to rid of moisture the air acquired from the water. The bulk of water in the filtration chamber 12 acts as a filter, which can be changed as needed, and has at least one kind of bactericide present that is renewable on occasion as needed.

In the electrolyzer 14 of the Air Purifier System 10 of the present invention, distilled water is continuously electrolyzed to generate hydrogen molecules 22 and oxygen molecules 24 in an electrolysis process using a proton exchange membrane or PEM cell. Depending on the size of the Air Purifier System 10, the amount of distilled water being electrolyzed is determined by the amount of oxygen needed to be added to the air. One example is between approximately fifty milliliters to approximately one liter. The fresh oxygen 24 generated by the electrolyzer is added to the purified air 26 on its way out of the filtration chamber 12. The hydrogen 22 generated by the electrolyzer 14 travels to the fuel cell 16 to generate electricity. Within the fuel cell 16, hydrogen from the electrolyzer 14 reacts with ambient outside or attic air to generate electricity 28 and water 30. The generated water 30 is sent back to the electrolyzer 14 to replace the already used water. The generated electricity 28 is used to compensate for part of the electricity consumption of the Air Purifier System 10.

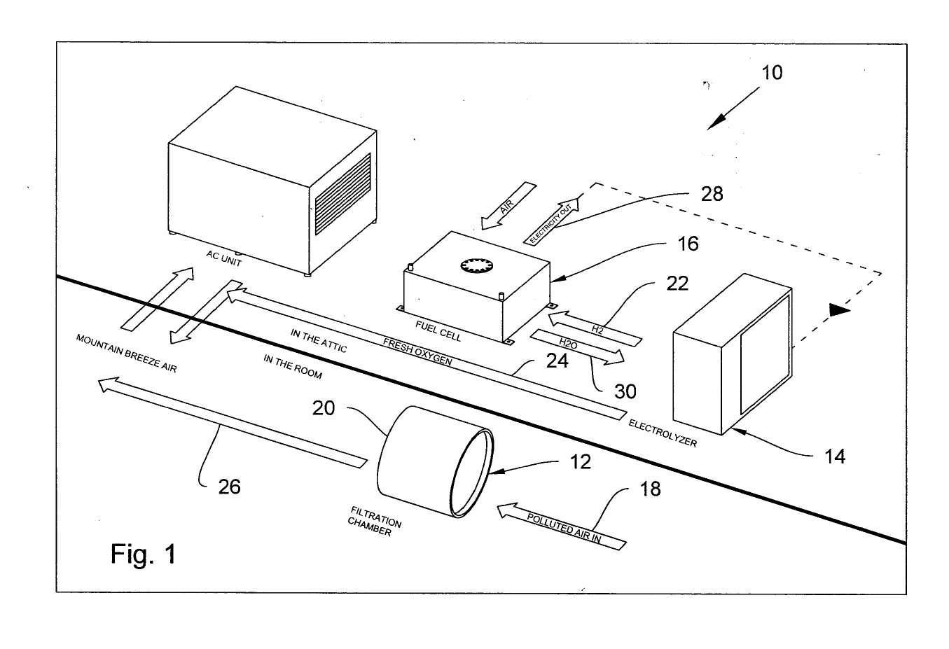

FIG. 1 shows fuel cell 16 and electrolyzer 14 separately for clarification, but both of these components can be housed in the same box or enclosure. Fresh oxygen leaves the electrolyzer 14 and combines with cooled air from the AC unit to provide fresh air.

The Air Purifier System 10 of the present invention utilizes a few appropriate technologies together in one sleek technical application tailored to convert air and expel purified mountainous air in homes, hospitals, casinos, businesses, cruise ships, and other inside facilities. The Air Purifier System 10 rids the air of particulates and gases completely. The present invention also adds fresh oxygen to the air, generates electricity, and provides individuals with fresh and healthy benefits of breathing purified mountainous like air. As a result, the Air Purifier System 10 effectively functions to reduce or eliminate the adverse health effects on humans caused by fine particulate and gaseous particles in a home or building. Using the present invention potentially reduces cases of Chronic Obstructive Pulmonary Disease or COPD, dementia and Alzheimer's, among many other health ailments.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An air purifier system for removing particulate matter and gaseous particles from polluted indoor air, the air purifier system comprising:
a filtration chamber having an amount of water, the filtration chamber capable of receiving the polluted indoor air, the polluted indoor air traveling through the water leaving behind particulate matter and gaseous particles in the water, cleaned air exiting the filtration chamber;
an electrolyzer for continuously electrolyzing distilled water to generate hydrogen molecules and oxygen molecules in an electrolysis process, the oxygen gases added to the cleaned air exiting the filtration chamber; and
a fuel cell receiving the hydrogen gases from the electrolyzer for generating electricity, the fuel cell electrically connected to at least the electrolyzer for at least partially powering the electrolyzer;
wherein the cleaned air exiting the filtration chamber is free from particulate matter and gaseous particles.

2. The air purifier system of claim 1 wherein the fuel cell and electrolyzer are located in an attic or outside a building and the filtration chamber is located in a room.

3. The air purifier system of claim 1 and further comprising:
a waterproof air permeable membrane mounted in the filtration chamber for reducing air moisture in the air exiting the filtration chamber.

4. The air purifier system of claim 1 and further comprising:
a bactericide within the water of the filtration chamber.

5. The air purifier system of claim 1 wherein the electrolyzer is a proton exchange membrane or PEM cell.

6. The air purifier system of claim 1 wherein the amount of distilled water being electrolyzed is between approximately fifty milliliters to approximately one liter.

7. The air purifier system of claim 1 wherein within the fuel cell, the hydrogen molecules from the electrolyzer react with ambient outside air to generate both electricity and water.

8. The air purifier system of claim 7 wherein the generated water from the fuel cell is returned to the electrolyzer.

9. The air purifier of claim 12 wherein generated electricity is used to compensate for part of the electricity consumption of the purifier.

10. A method for removing particulate matter and gaseous particles from polluted indoor air, the method comprising:
providing a filtration chamber having an amount of water;
introducing polluted indoor air into the filtration chamber;
contacting the polluted indoor air with the water;
removing particulate matter and gaseous particles in the water;
expelling cleaned air from the filtration chamber;
providing an electrolyzer;
continuously electrolyzing distilled water in the electrolyzer;
generating hydrogen molecules and oxygen molecules in an electrolysis process;
adding the oxygen molecules to the cleaned air exiting the filtration chamber;
providing a fuel cell;
introducing the hydrogen molecules from the electrolyzer into the fuel cell;
generating electricity from the hydrogen molecules;
electrically connecting the fuel cell to at least the electrolyzer; and
at least partially powering the electrolyzer.

11. The method of claim 10 and further comprising:
positioning the fuel cell and electrolyzer in an attic or outside a building; and
positioning the filtration chamber in a room.

12. The method of claim 10 and further comprising:
mounting a waterproof air permeable membrane in the filtration chamber; and
reducing air moisture in the air exiting the filtration chamber.

13. The method of claim 10 and further comprising:
providing a bactericide within the water of the filtration chamber.

14. The method of claim 10 wherein the electrolyzer is a proton exchange membrane or PEM cell.

15. The method of claim 10 wherein the amount of distilled water being electrolyzed is between approximately fifty milliliters to approximately one liter.

16. The method of claim 10 and further comprising:
reacting the hydrogen molecules from the electrolyzer with ambient outside air to generate both electricity and water.

17. The method of claim 16 and further comprising:
returning the generated water from the fuel cell to the electrolyzer.
